(19) United States
(12) Patent Application Publication
(10) Pub. No.: US 2024/0116656 A1
(43) Pub. Date: Apr. 11, 2024

(54) REACTIONLESS STEERABLE PROPULSION VEHICLE - MESH DRIVE

(71) Applicant: SpaceDyne Technologies, LLC, Land O Lakes, FL (US)

(72) Inventor: Jesse W. Flippo, JR., Land O Lakes, FL (US)

(73) Assignee: SpaceDyne Technologies, LLC, Land O Lakes, FL (US)

(21) Appl. No.: 17/958,353

(22) Filed: Oct. 1, 2022

(51) Int. Cl. B64G 1/40; B64G 1/24; B64G 1/28

(52) U.S. Cl. CPC B64G 1/409; B64G 1/242; B64G 1/28; F03G 3/097

(57) ABSTRACT

A drive is provided that comprises at least one pair of coaxial linear guides configured to counterrotate about a rotational axis and a pair of eccentric masses arranged and constrained for reciprocating movement along the coaxial linear guides. Each eccentric mass reciprocates from a first end to a second end and back again to the first end of its corresponding linear guide in a first period of time that is equal to a second period of time required for the corresponding linear guide to complete a full rotation. This results in a phenomenon by which the eccentric masses are constrained to one hemisphere of the circular sweep of the linear guides, producing an internally derived directional thrust. To steer the drive, one of several different mechanisms are used to differentiate the phases, angular momentums, and or displacement between the linear guides of the linear guide-and-piston subsystems.

### TECHNICAL FIELD

This application relates to steering and propulsion mechanisms associated with an internal reaction system that creates a directional force for motivation of a vehicle.

### SUMMARY

A vehicle is described comprising a frame, at least first and second rotating linear guides, and at least first and second reciprocating/counter-revolving masses, and one or more actuators. The first and second linear guides are coupled to the frame for counter-rotating movement about a common axis of rotation. The first and second masses are mounted to the linear guides and guided and configured to reciprocate along the length of the linear guides as the linear guides rotate about the common axis of rotation. One or more actuators are coupled to the first and second linear guides to counter-rotate the first and second linear guides and reciprocate the first and second counter-revolving masses along the travel lengths of the linear guides as they rotate. The first and second masses each can travel in opposite directions or in the same direction about congruent coaxial orbit functions centered about a common orbital axis depending on the force outcome desired. The congruent coaxial orbit functions (also known as orbit functions) are offset from the sweep of the linear guides. Accordingly, the common orbital axis is displaced from the common axis of rotation. In a first mode of operation, the first and second masses each travel in opposite rotational directions about congruent coaxial orbit functions, which congruent coaxial orbit functions are centered about an orbital axis that is displaced from the common axis of rotation.

In one embodiment, the vehicle also features first and second linear actuators mounted on the first and second linear guides, respectively, that propel the first and second counter-revolving masses to reciprocate along the respective travel lengths of their respective linear guides. In one implementation, at least a portion of the first and second linear actuators are contained within the first and second counter-revolving masses, respectively. In addition or in the alternative, the vehicle comprises one or more rotational actuators that counter-rotate the linear guides.

In the first mode of operation, each counter-revolving mass intersects the common axis of rotation of the linear guides at one point along the mass's orbit. The first mode is characterized by the counter-revolving masses orbiting their respective orbital paths at constant angular speeds, resulting in each counter-revolving mass moving at a sinusoidal speed, with respect to the linear guide, between a first end and an opposite end of the travel length of the respective linear guide. In this mode, the sinusoidal speed of each counter-revolving mass reaches a minimum at opposite ends of the travel length of its linear guide, which occurs when the linear guide is oriented along a first line intersecting two points along the masses' orbital paths where the masses overlap. Also, the sinusoidal speed of each counter-revolving mass reaches a maximum when the counter-revolving mass intersects the common axis of rotation, which occurs when the linear guide is oriented along a second line that intersects the common axis of rotation that is perpendicular to the first line.

Characterized another way, each counter-revolving mass is arranged to reciprocate along the travel length of its corresponding linear guide and back again in a first period of time that is equal to a second period of time required for the corresponding linear guide to complete a full rotation. Under this mode, each of the first and second counter-revolving masses complete two revolutions about its respective orbital axis for every single complete 360° rotation of the first and second linear guides.

In another embodiment, the vehicle comprises a second mode of operation in which the first and second masses each travel in opposite rotational directions at equal and opposite speeds about noncongruent and non-coaxial orbit functions. This causes the vehicle to steer.

Most practical embodiments will include a controller that is either directly or remotely controlled. For example, in one embodiment, a controller receives remote commands and responsively controls the angular speeds of the linear guides.

In another embodiment, the controller also controls a length of reciprocation of the first and second masses. The controller steers the vehicle by driving the first and second counter revolving masses at opposite and equivalent speeds wherein the first mass's orbit has a mean eccentricity from the common axis of rotation that is greater than or less than a mean eccentricity of the second mass's orbit. In another embodiment, the controller steers the vehicle by changing a phase between the rotational orbits of the first and second counter-revolving masses. The first and second masses, when rotated at equal and opposite angular velocities, result in the masses overlapping each other at two opposite points along their orbital paths, producing thrust along a vector that intersects said two opposite points. Changing the phase between the angular velocities rotationally shifts positions of the two opposite points along the circular orbital paths at which the masses overlap.

In one embodiment, the controller controls a forward acceleration of the vehicle by through the use of two sets of counter-rotating linear guides operating perpendicular to one another and 90° or

$$\frac{1}{2} π$$

out of phase (see FIG. 1) so that the interlaced linear guides do not collide with one another, and with the controller manipulating each of the respective orbits functions of each of the 4 masses. An acceleration component of a magnitude of thrust generated by counter-rotation of the two sets of linear guides and synchronized reciprocation of the 4 masses based on specific orbit functions is characterizable by the formula:

$$\\ {A}_{drive} = 2 \frac{{m}_{piston}}{{m}_{vehicle}} * {r}_{max} {ω}^{2}$$

where mₚᵢₛₜₒₙ is the mass of a single piston (assuming all pistons are of equal mass), m_{drive} is the mass of the drive system, rₘₐₓ is the radius of the maximum concentric orbits of the first and second eccentric masses, and ω is the angular speed, in radians, of each of the first and second eccentric masses. Angular speed for all rotating guides are equal.

Other systems, devices, methods, features, and advantages of the disclosed product and methods for creating a steerable drive propulsion system will be apparent or will become apparent to one with skill in the art upon examination of the following figures and detailed description. All such additional systems, devices, methods, features, and advantages are intended to be included within the description and to be protected by the accompanying claims.

### BRIEF DESCRIPTION OF THE DRAWINGS

The present disclosure may be better understood with reference to the following figures. Corresponding reference numerals designate corresponding parts throughout the figures, and components in the figures are not necessarily to scale.

It will be appreciated that the drawings are provided for illustrative purposes and that the invention is not limited to the illustrated embodiment. For clarity and in order to emphasize certain features, not all of the drawings depict all of the features that might be included with the depicted embodiment. The invention also encompasses embodiments that combine features illustrated in multiple different drawings; embodiments that omit, modify, or replace some of the features depicted; and embodiments that include features not illustrated in the drawings. Therefore, it should be understood that there is no restrictive one-to-one correspondence between any given embodiment of the invention and any of the drawings.

FIG. 1 is an illustration of one embodiment of a self-guiding vehicle utilizing two meshing pairs of counter-rotating piston guides mounted to a central frame.

FIG. 2 is a simplified diagram of a piston guide whose piston is driven to reciprocate back and forth while the piston guide rotates.

FIG. 3 is a perspective drawing of an embodiment of a self-guiding vehicle that includes an outer frame.

FIG. 4 is a perspective drawing of an embodiment of a self-guiding vehicle that includes an outer enclosure.

FIG. 5 is a perspective drawing of another embodiment of a self-guiding vehicle that provides both an outer frame and inner enclosures for the linear guides.

FIG. 6 is a perspective drawing of piston guide and associated components.

FIG. 7 is a force vector diagram identifying the reactionary forces acting on the piston 18 as it travels along its orbit.

FIG. 8 illustrates the orbit of the piston and the orbit of the center of mass in relation to the center of rotation as the linear guide rotates.

FIG. 9 illustrates the reactionary forces produced by movements of the piston around its orbit.

FIG. 10 illustrates the piston guide positioned at an angle of θ=0 or 2π, at which angle the piston is extended its full rₘₐₓ distance away from the center of rotation.

FIG. 11 illustrates the piston guide the piston guide 14 positioned at an angle of

$$\\ θ = \frac{π}{4} or \frac{5 π}{4} .$$

FIG. 12 illustrates the piston guide positioned at an angle of

$$\\ θ = \frac{π}{2} or \frac{3 π}{2} .$$

FIG. 13 illustrates the piston guide positioned at an angle of

$$\\ θ = \frac{3 π}{4} or \frac{7 π}{4} .$$

FIG. 14 illustrates a pair of piston guides mounted for counter-rotation on a central vehicle frame or chassis.

FIG. 15 illustrates the relationship between the angle φ of the piston and the angle θ of the piston guide.

FIG. 16 illustrates the movement of two counter-rotating pistons through their overlapping piston orbits in 30° increments of a 360° period of the piston guides.

FIG. 17 illustrates one embodiment of a piston constrained to move along a linear guide.

FIG. 18 is a top view of one embodiment of a piston constrained by both a linear guide and a circular track, using only a single actuator centered along the axis of the piston orbit.

FIG. 19 is a perspective view of the embodiment of FIG. 18.

FIG. 20 illustrates another embodiment of a piston constrained by both a linear guide and a circular track, using only a single actuator centered at the axis of rotation of the linear guide.

FIG. 21 is a continuation of FIG. 20 illustrating the connection points of the piston guide with the single actuator centered at the axis of rotation.

### DETAILED DESCRIPTION

Any reference to “invention” within this document is a reference to an embodiment of a family of inventions, with no single embodiment including features that are necessarily included in all embodiments, unless otherwise stated. Furthermore, although there may be references to “advantages” provided by some embodiments, other embodiments may not include those same advantages, or may include different advantages. Any advantages described herein are not to be construed as limiting to any of the claims.

Specific quantities (e.g., spatial dimensions) may be used explicitly or implicitly herein as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated.

In describing preferred and alternate embodiments of the technology described herein, specific terminology is employed for the sake of clarity. Technology described herein, however, is not intended to be limited to the specific terminology so selected, and it is to be understood that each specific element includes all technical equivalents that operate similarly to accomplish similar functions.

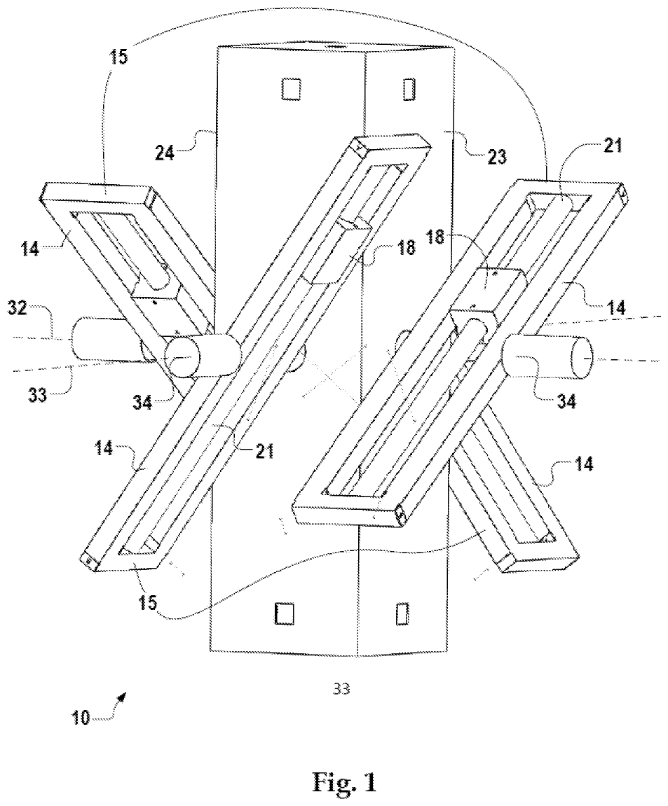

FIG. 1 illustrates one embodiment of a free-body, self-guiding vehicle 10 comprising two pairs of counter-rotating linear guides 14 (usually referred to herein as “piston guides”) mounted to an elongated central vehicle chassis or frame 24. The first and second pairs 15 of piston guides 14 rotate along first and second axes 32 and 33, respectively. The first axis 32 is orthogonal to the second axis 33. Each piston guide 14 is mounted for mechanically powered rotation at their respective centers of rotation (COR) 34. Each guide 14 is mounted for rotation with respect to the frame 24 via drive couplings to the plurality of rotational actuators 16, which are also mounted to the frame 24.

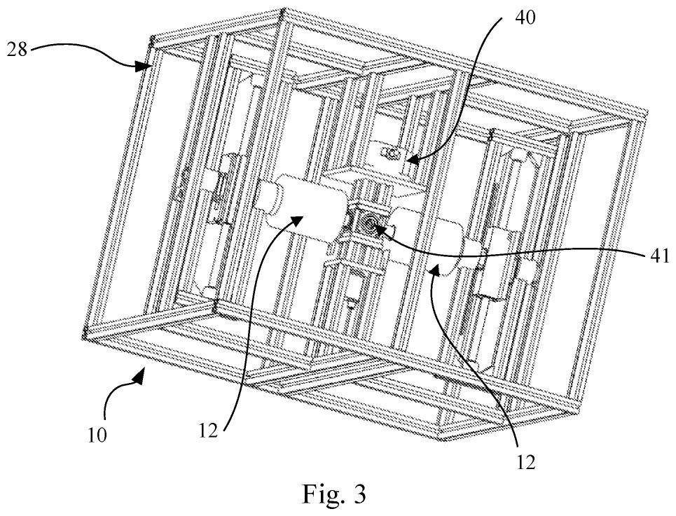

Rotational actuators 12 (FIG. 3) mounted in the frame 24 and optionally concealed within an actuator enclosure 22 and/or a central frame enclosure 23 provide mechanical power to rotate the guides 14. Alternatively, the rotational actuators 12 are mounted outside of the central frame enclosure 23. Within each pair of piston guides 14, the piston guides 14 counter-rotate, that is, they rotate oppositely of each other.

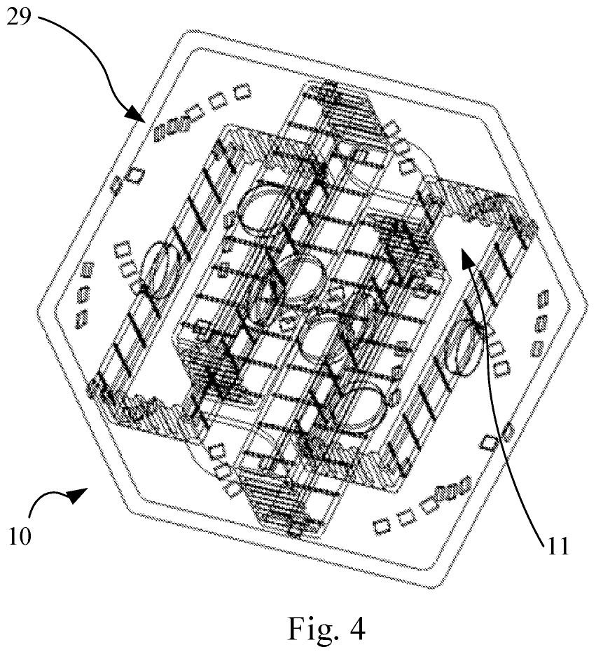

To make the vehicle 10 compact, the linear guides 14 are arranged, 90° apart, in a square pattern around and facing outward from the elongated central frame member 24. In a passive and retracted mode, the linear guides 14 are driven to positions parallel to each other and to the frame member 24, as shown in FIG. 4. In an active single-pair mode, a single pair of linear guides 14 is driven at a time. Steering along one axis can be accomplished by counterrotating the linear guides at different speeds. Steering along an orthogonal axis can be accomplished by returning the first pair 14 to the passive and retracted mode, and activating the other pair 15.

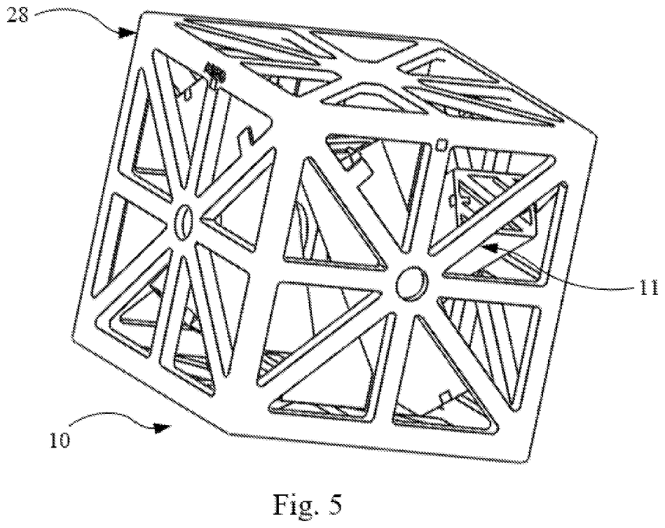

In an active dual-pair (or mesh) mode, both pairs of linear guides are driven at the same time at the same angular speeds to prevent their interference. The first pair of linear guides 14 is about 90° (i.e., close enough to 90° to avoid interference) out of phase with the second pair 15 of linear guides 14. FIGS. 1 and 5 illustrate moments in which the linear guides 14 are in such a mesh configuration. It is evident that the first, second, third, and fourth rotational guides mesh with each other as they rotate about their perpendicular axes without colliding with each other.

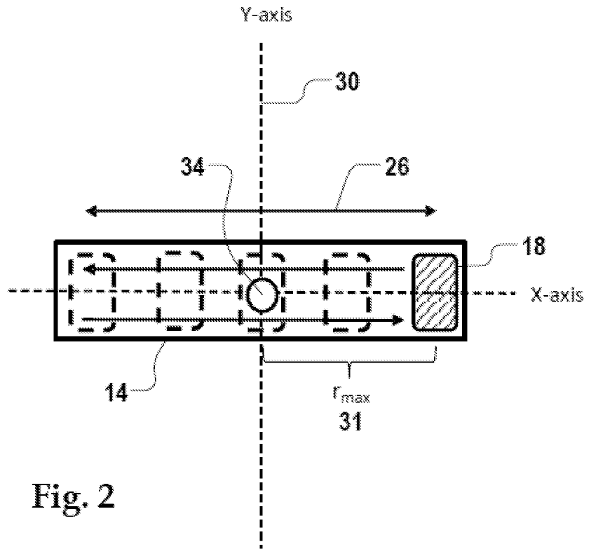

On each piston guide 14, a track 21 such as a rod, beam, rail, shaft, or other guide member carries an eccentric mass 18, referred to herein as a “piston” (broadly construed) for ease of comprehension. Linear actuators 16—preferably embedded within the piston 18 itself—drive 7 the pistons 18 back and forth along a travel length 26 (FIG. 2) of the piston guide 14 as the piston guide 14 rotates around its COR 34. Note that when the term “piston” is used because the motion of the eccentric mass 18 resembles the movement of a piston within a cylinder. However, as used in this specification and claims, “piston” is not limited to traditional notions and definitions of pistons, which typically involve disks or cylinders fitting closely within a tube. Rather, the term “piston” herein encompasses any eccentric mass that is linearly guided along a rod, track, or body.

It will be noted that each piston 18 is driven to move by two forces—the centrifugal forces applied by the rotation of the linear guide 14 and the centripetal forces applied by the linear actuators 16 driving the piston 18. It will be further noted that the linear guides 14 of each pair 15 rotate about a shared (collinear) axis—that is, their axes of rotation are not offset from each other but could be offset. Also, within each pair 15 of linear guides 14, the linear guides 14 have the same length, mass, and structural configuration.

In various embodiments, several different types of linear actuators 16 are employed. These types include electro-mechanical, hydraulic, pneumatic and magnetic actuators. In some embodiments, a linear actuator 16 is completely or at least partly contained within the piston itself. Therefore, it moves with the piston 18 along the linear rod, beam, rail, shaft 21 or other guide that secures the eccentric mass 18 to itself and enables travel along itself. Advantageously, incorporating the linear actuator 16 into the piston 16 adds the mass of the linear actuator 16 to the numerator of the eccentric mass/total mass ratio.

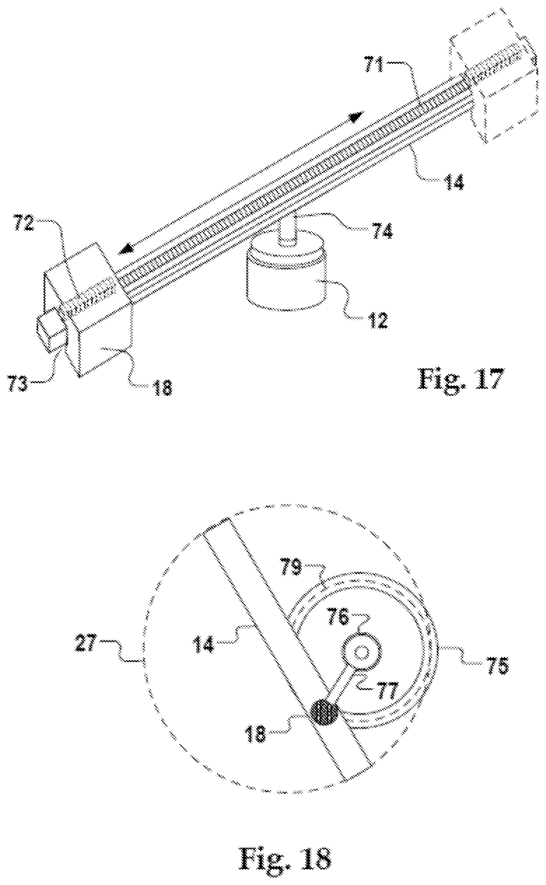

In the embodiment of FIG. 17, for example, the linear actuator 16 is magnetic and comprises both one or more magnetic and/or electromagnetic propulsion tracks 71 embedded in the linear guide 14 itself and one or more magnetic and/or electromagnetic propulsion coils 72 embedded within the piston 18 itself. Other magnets and/or electromagnets are positioned near the interface between the piston 18 and the linear guide 14 to maintain an essentially frictionless gap between them. An open slot 73 along one side of the piston 18 allows the piston 18 to slide along the full length of the linear guide 14 without interfering with the rotor 74 of the rotational actuator 12. Electrical circuitry and electromagnets in the piston 18 are inductively powered or powered by one or more electrodes 78 embedded in the surface of the linear guide 14.

There are many examples of rectilinear and/or cylindrical magnetic linear drives in the art, including, for example, Sun, Zhengang & C. Cheung, Norbert & Pan, J. F. & Zhao, Shiwei & Gan, Wai-Chuen, “Design and simulation of a magnetic levitated switched reluctance linear 8 actuator system for high precision application,” IEEE International Symposium on Industrial Electronics (2008), at pp 624-629, which is herein incorporated by reference.

Advantageously, the use of eccentric masses 18 driven by linear actuators 16 on each guide 14 enables another steering mechanism. Even though all four linear guides 14 and are driven at equal angular speeds, steering is still obtainable through a clever mechanism. Controlling the relative moments of the eccentric masses 18—by, for example, keeping one eccentric mass 18 closer to the linear guide 14's center of rotation than the opposite eccentric mass 18—causes the moment produced by rotation of one of the linear guides 14 to differ from the moment produced by the other. This way, the vehicle 10 is operable to steer itself in free space about two axes at the same time with both pairs 15 of counter-rotating piston guides 14 non-interferingly rotating.

This yields yet another advantage. While the above embodiment contemplates a single rotational actuator 12 for each linear guide 14—so that they could be independently driven at different speeds—in another embodiment, a single rotational actuator 12 and gearbox drives both counter-rotating linear actuators 16, because steering can be accomplished even if the linear guides 14 are all driven to rotate simultaneously at the same speed. In yet another embodiment, a single rotational actuator 12 and gearbox drives all four of the linear actuators 16.

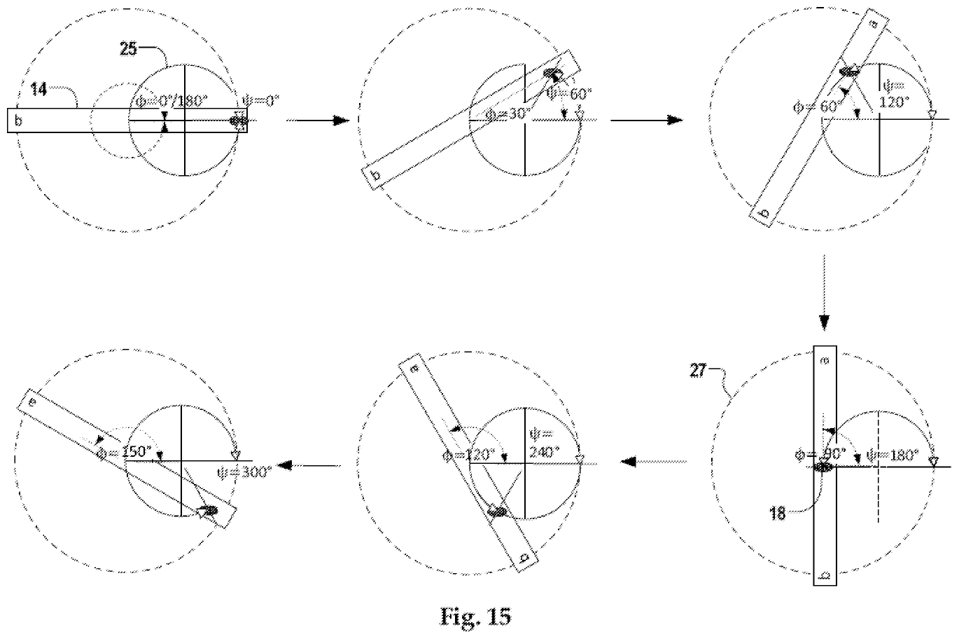

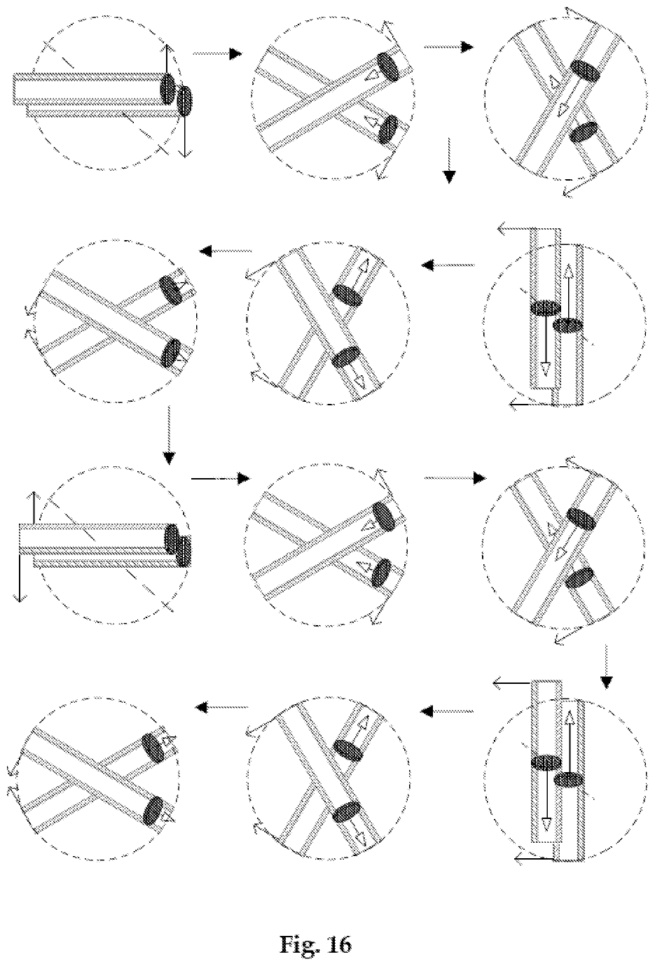

In one implementation, the rotational actuators 12 and linear actuators 16 are synchronized such that each eccentric mass 18 is driven across the full travel length of the linear guide 10 and back twice for each full 360° rotation of the linear guide 10. This produces two fascinating results. First, the eccentric mass 18 travels about an inner orbit that is contained within one hemisphere of the circular sweep 27 of the linear guide 14. Second, the eccentric mass 18 completes its orbit at twice the frequency of the linear guide 14. This is illustrated in FIGS. 15 and 16.

As explained further below, Applicant has found that this symmetry produces an unexpected result. In a test on a mass scale, operation of a model of the vehicle 10 was demonstrated to cause a deviation in the measured mass. Because there could be more than one explanation for this behavior, a more rigorous test was performed.

In order to maximize the maneuverability and thrust of the vehicle 10, the ratio of the eccentric masses 18 to the mass of the entire vehicle 10 is kept as large as is feasible given strength and wear requirements. In particular, the linear guide 14 and frame (or vehicle chassis) 9 are made of lightweight components such as fiberglass or 3D graphene. The eccentric mass 18, on the other hand, is made of high-density material such as lead or depleted uranium.

In FIGS. 4 and 5, the linear guides 14 are illustrated as having chasses 11. The chasses 13, however, may not be necessary. In other embodiments, a higher eccentric mass-total vehicle mass ratio is achieved by excluding the chasses 11 and simply having the eccentric mass travel back and forth along the guide shaft 21.

The vehicle 10 also comprises an on-board energy source 40 for driving the rotational and linear actuators 12 and 16 and a controller or servo 41 that receives and/or generates digital command signals processes them to control the speed, acceleration, and phase of the rotational guides 12 and the travel distance, speed, and trajectory (e.g., sinusoidal or impulse-like) of the eccentric masses 18. Different embodiments of energy sources include a battery, fuel, or a lightweight nuclear microreactor.

In a non-turning mode, the first and second linear guides 14 of each pair 15 rotate oppositely of each other at equal speeds. In one embodiment of a turning mode, the controller 41 steers the vehicle 10 by changing the relative phases of the counter-rotating rotational guides or by causing one of the pair's linear guides 14 travel at a different angular speed than the other of the pair's linear guides 14. Because the vehicle 10 is equipped with two pairs 15 of counterrotating linear guides 14, it can effectively rotate the vehicle 10 into any orientation. In another embodiment of a turning board, the controller 41 steers the vehicle 10 by selectively limiting the travel length of one of the pistons 18 of at least one pair of piston guides 14, so that one of the pistons 18 of the pair 15 is, on average, closer to the COR 34 than the other piston 18. The controller 41 can alternatively transition the pistons 18 of at least one of the pairs of piston guides 14 from a reciprocating motion along the guides 14 to a non-reciprocating motion with one of the pistons 18 being in a more retracted state (i.e., closer to the pivot point 34) than the other of the pistons 18.

In either of the aforementioned steering modes, the controller 14 can operate a single pair 15 of piston guides 14 to steer the vehicle 10 along an axis perpendicular to a plane parallel to the two piston guides 14. With the second set of piston guides 14 oriented perpendicularly to the plane of the first pair of piston guides 14, the controller 14 can operate both pairs 14 to steer the vehicle in any direction.

FIG. 2 diagrams an embodiment of a piston guide 14 that carries a piston 18. The piston 18 is driven—in one embodiment by a linear actuator 16 incorporated into the piston 18—to reciprocate back and forth while the piston guide 14 rotates. In order to analyze the forces acting on the piston 18, a conceptualized cartesian coordinate system (CCS) 30 is centered at the pivot point and center of rotation (COR) 34 of the piston guide 14. The CCS 30 is oriented so that the piston 18 is at its maximum distance rₘₐₓ from the guide's COR 34 at an angle of 0 or 2π(n) from the X-axis. The piston 18 travels back and forth along the travel length 26 of the piston guide 18. The maximum displacement distance rₘₐₓ 31 (a scalar quantity) of the piston 18 from the COR 34 is equal to ½ of the travel length 26 of the piston 18.

FIG. 3 provides a perspective view of an embodiment of a self-guiding vehicle that includes an outer frame 28. For clarity, no actuator enclosure 22, central frame enclosure 23 or outer enclosure 29 is shown. Also, only a single pair 15 of piston guides 14 and their rotational actuators 12 are shown. FIG. 4 provides a perspective drawing of an embodiment of a self-guiding vehicle 10 with an outer enclosure 29. FIG. 5 provides a perspective drawing of another embodiment of a self-guiding vehicle 10 that provides both an outer frame 28 and linear guide enclosures 11 for the linear guides 14.

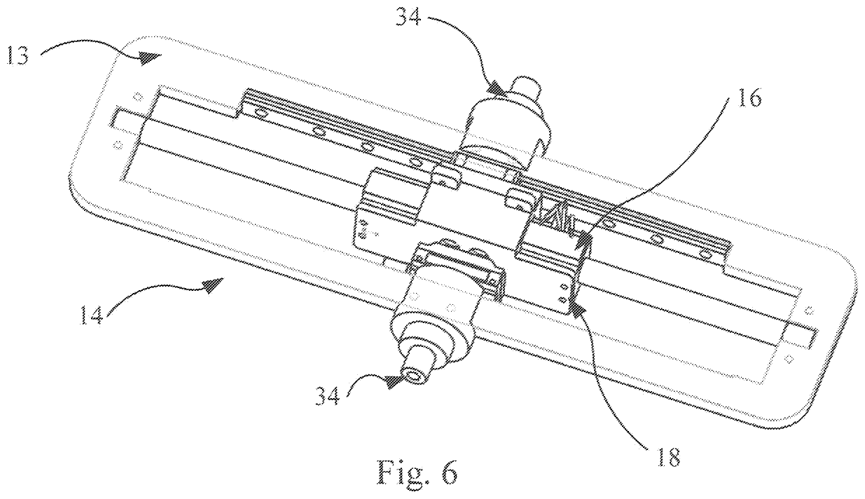

FIG. 6 is a perspective view of one embodiment of a linear guide 14 comprising a linear guide chassis 13, dual pivots 34, an eccentric mass or piston 18, and a track 21 (e.g., rod, beam, rail or shaft) The linear actuator 16—for example, a magnetic drive that provides long reliability with minimal wear—is incorporated into the piston 18.

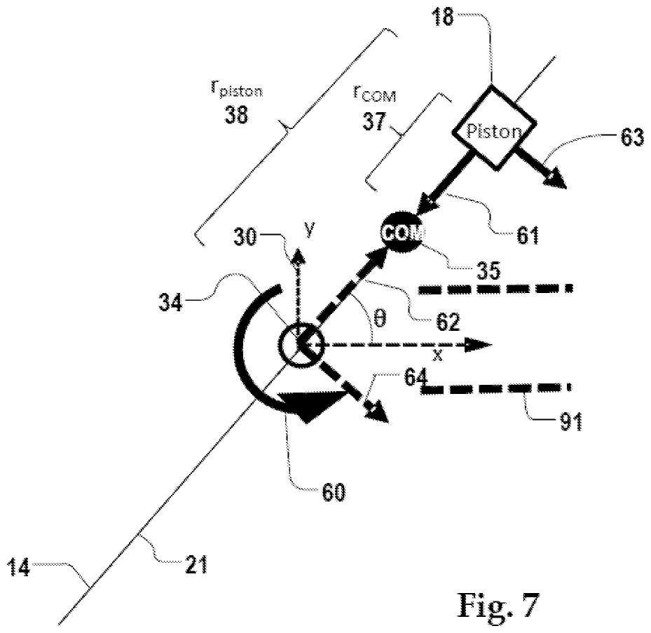

FIG. 7 is a force vector diagram identifying the reactionary forces 62 and 64 acting on the piston 18 as it travels along its orbit 25. FIG. 7 also marks polar unit vectors er and eθ in relation to the piston 18. A rod, beam, rail or shaft 21 of a linear piston guide 14 is centered on a CCS 30. The center of the piston guide 14 coincides with the pivot point or COR 34 of the piston guide 14. The direction of rotation 60 of the piston guide 14 is given by the arrow arcing around the COR.

As the piston guide 14 rotates, the piston 18 moves back and forth along the piston guide 14. The piston's scalar distance rₚᵢₛₜₒₙ 38 is measured from the COR 34 to piston 18 and is given by the following formula:

rₚᵢₛₜₒₙ=rₘₐₓ cos(θ) (1)
where θ is the angle of the piston guide 14 to the X-axis. The alternative distance r_{com} 37 is measured from the COR to the center of mass (COM) 35 of the piston guide 14 plus piston 18 subsystem.

Rotation of the piston 18 about the COR 34 and linear translation of the piston 18 along the travel length 26 of the piston guide 14 produce radial and transverse forces 61 and 63 that act on the piston 18. The radial forces 61 are the sum of the centrifugal forces caused by the piston guide's rotation and the linear actuator forces required to move the piston 18 toward, or resist the piston's movement away from, the COR 34.

The transverse force 63 is caused by the contraction and expansion of the radial path of the piston around the COR, which results in acceleration and deceleration of the piston 18 even though the rotational frequency co of the piston guide 14 will typically stay constant. The radial and transverse forces 61 and 63 acting on the piston 34 are balanced by radial and transverse reactionary forces 62 and 64 acting on the piston guide 14, which are translated through the pivot point 34 to the vehicle chassis 24.

Because the counter-rotating piston guides 14 produce equal and opposite transverse force y-components (assuming that the guides' mass, configuration, and angular speed are equal), they cancel each other out. This leaves two reactionary transverse force x-components, one for each piston guide subsystem, accelerating the vehicle 10 along the x-axis. The channel 91 markers illustrate how the vehicle 10 with a single pair 15 of counter-rotating pistons 14 is constrained to move in one direction.

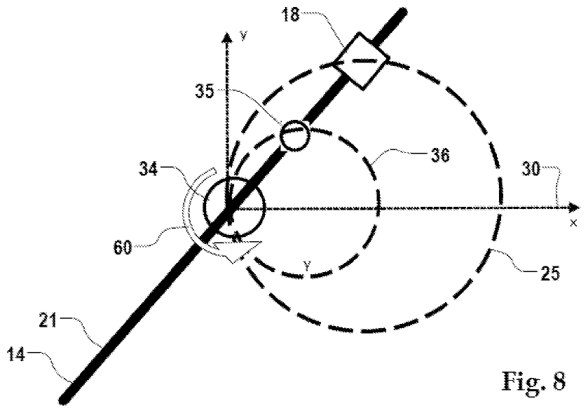

FIG. 8 shows the orbit 25 of the piston 18 and the orbit 36 of the COM 35 in relation to the COR 34 as the linear guide 14 rotates. As illustrated by the intersection of the linear guide 14 with the orbits 25 and 36, the COM 35 of the piston guide 14 and piston 18 subsystem is always in between the COR 34 and the piston 18's own center of mass. Where the mass of the piston 25 equals about one-half of the mass of the sum of the masses of the piston guide 14 and piston 18, the orbit function of the COM 35 can be expressed as:

$$\\ \begin{matrix}{r}_{com} ≅ \frac{1}{2} {r}_{max} cos ( θ ) & ( 2 )\end{matrix}$$

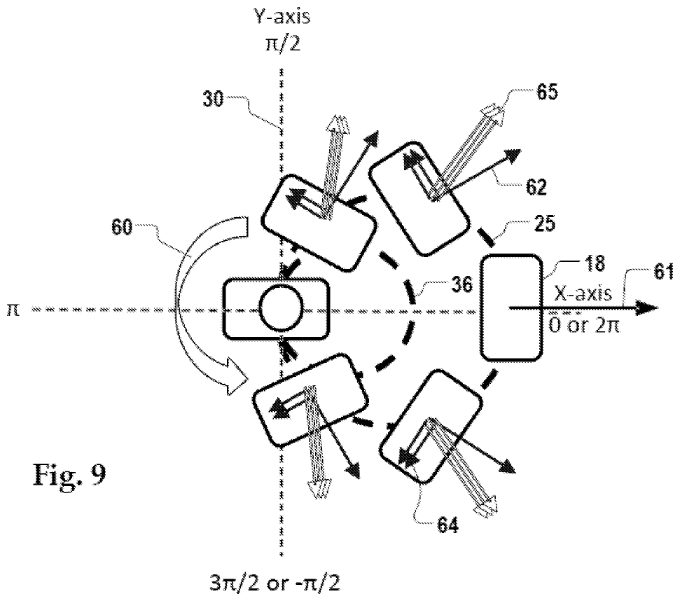

FIG. 9 illustrates the reactionary forces produced by movements of the piston 18 around its orbit 25. The forces are translated through the COR 34 to the vehicle chassis 24. However, in FIG. 9, they are shown as emanating from the piston 18 itself to illustrate how these forces change over time. Single arrowed force vectors represent the reactionary radial forces 62 produced by piston 18's acceleration and deceleration. Double arrowed force vectors represent the reactionary transverse forces 64 produced by piston acceleration and deceleration. Triple arrowed force vectors represent the resultant forces 65—i.e., the combination of the reactionary radial and transverse forces 62 and 64—acting on the piston 18. Note that as the piston 18 passes through the COR 34, the forces 62, 64 and 65 approach zero, and that as the piston reaches rₘₐₓ, the reactionary radial force 62 and 64 reach their maximums.

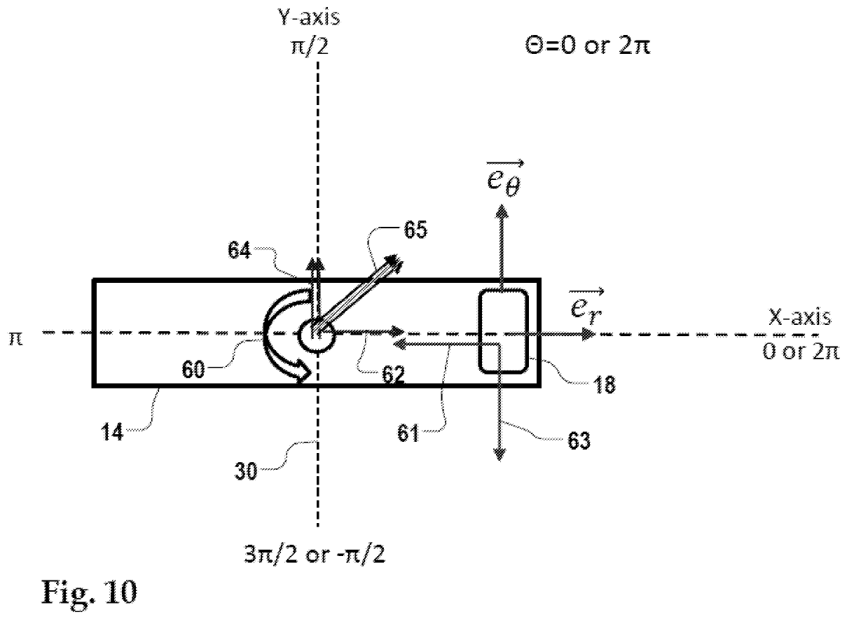

FIGS. 10-13 illustrate the force vectors acting on the piston 18 as the piston guide 14 travels around the COR 34. FIG. 10 illustrates the piston guide 14 positioned at angle θ=0 to 2π, with the piston 18 extended its full rₘₐₓ distance away from the COR 34. The forces acting on the piston include both radial and transverse forces 61 and 63. The radial force 61 is the force exerted by the linear actuator 16 to resist and overcome the centrifugal force and motivate the piston 18 toward the COR 34. The transverse force 63 is the force required to slow the piston 18 down as the piston is urged toward the COR 34. This results in equal and opposite reactions, a radial reactionary force 62 and a transverse reactionary force 64. FIG. 10 also illustrates the resultant reactionary force 65, which is the sum of the radial and transverse reactionary forces 62 and 64. Importantly, net reactionary resultant force 65 is always non-negative. This gives rise to the thrust exhibited by the vehicle 10.

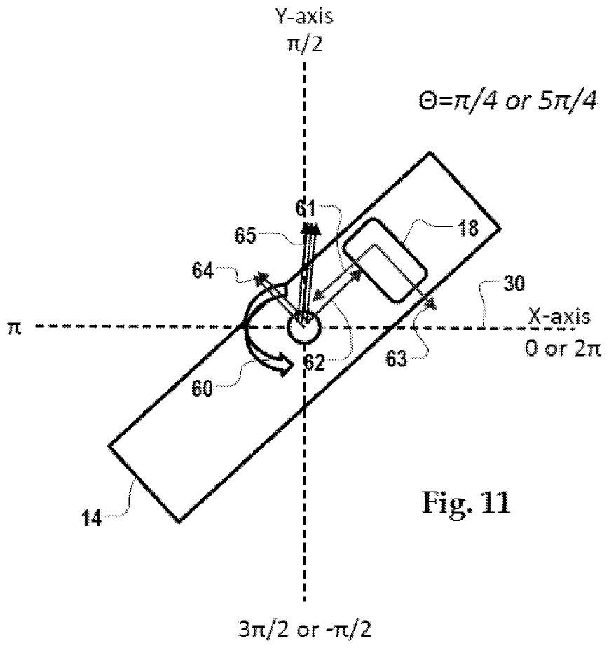

FIG. 11 illustrates the piston guide 14 positioned at angle

$$\\ θ = \frac{π}{4} or \frac{5 π}{4} .$$

Despite the 20 centrifugal force, the piston is advancing toward the COR 34. Accordingly, there is a net radial force 61, which induces a reactionary force 62 in the opposite direction.

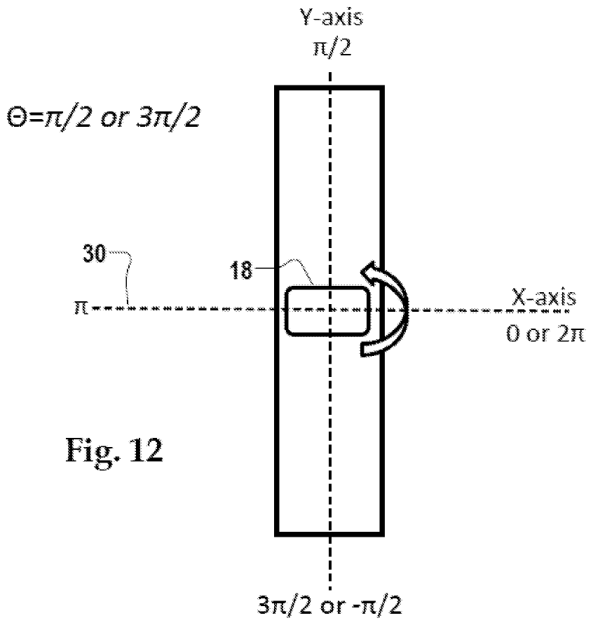

FIG. 12 illustrates the piston guide 14 positioned at angle

$$\\ θ = \frac{π}{2} or \frac{3 π}{2} .$$

In FIG. 12, the piston 18 is located at the COR 34. Therefore, all forces acting on the piston 18 at this point equal zero. Likewise, the acceleration of the piston 18 is zero.

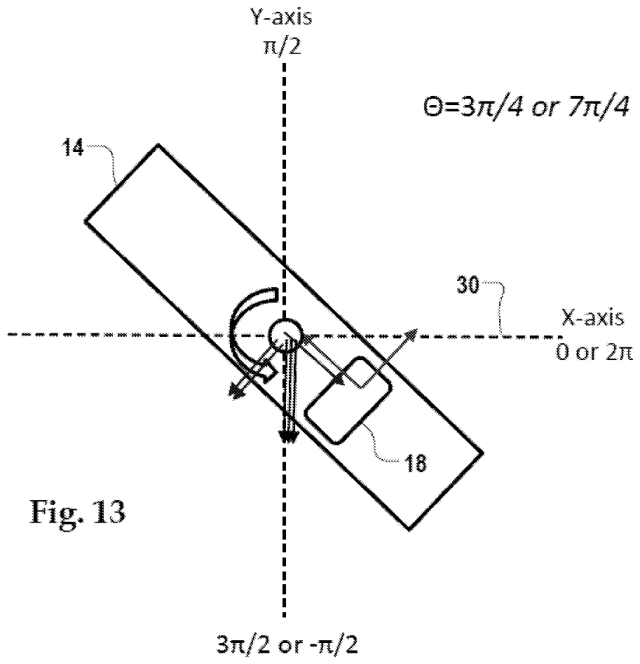

In FIG. 13, the piston guide 14 is positioned at angle

$$\\ θ = \frac{3 π}{4} or \frac{7 π}{4} .$$

Here, the piston 18 is advancing toward its rₘₐₓ displacement distance. However, it does so at a decelerating rate. This is in spite of the centrifugal forces acting to accelerate the piston 18 away from the COR 34. Accordingly, at

$$\\ θ = \frac{3 π}{4} or \frac{7 π}{4} ,$$

there is a net radial force 61 in the direction of the COR 34, just as there is when

$$\\ θ = \frac{π}{4} or \frac{5 π}{4} .$$

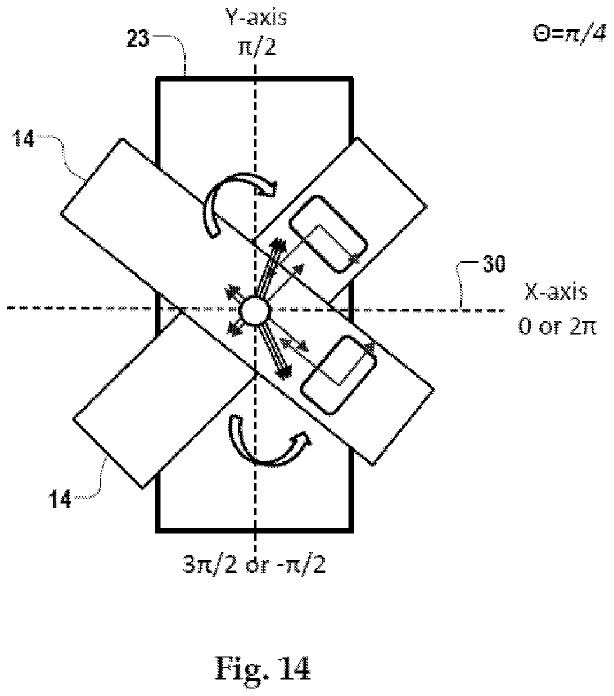

FIG. 14 illustrates a pair 15 of piston guides 14 mounted for counter-rotation on a central vehicle frame or chassis 24. As is apparent from the forces diagramed in FIG. 14, the y-values cancel out while the x-values are complimentary. It will be noted that the two eccentric masses or pistons 18 rotate around a common axis and when operated at an equal and opposite speed overlap each other at two points—φ=0 and π—along their overlapping orbital paths 25. Operation of the rotational actuators 12 to produce counter-rotation in equal and opposite directions causes the steerable vehicle 10 to accelerate along a linear path that intersects these two opposite points.

FIG. 15 illustrates the relationship between the angle φ of the piston 18 with respect to the center of its orbit 25 (solid line) and the angle θ (dashed line) of the piston guide 14 with respect to the COR 34.

FIG. 16 illustrates the movement of two counter-rotating pistons 18 through a full 360° rotation of the piston guides 14.

As stated above, Applicant has discovered that the vehicle 10 exhibits thrust, or net unidirectional acceleration, as it operates.

In Marc G. Millis and Nicholas E. Thomas's “Responding to Mechanical Antigravity” paper, published by the American Institute of Aeronautics and Astronautics in 2006, NASA advised that a fitting test for a purportedly reactionless drive is to place the device and its self-contained power supply on a pendulum, and compare the deflection between on and off conditions of the device. A sustained net deflection of the pendulum would be strong evidence, say the authors, of genuine thrust.

The suggested test was performed on a model of the vehicle 10. The vehicle 10 hung from a pendulum. The counter-rotating pistons (i.e., the eccentric masses) 18 were made to actively and oppositely revolve about coaxial piston orbits 25. The vehicle 10 weighed 32 kg, while the pistons' collective weights were 0.226 kg. The vehicle 10 was suspended from above by a 2.5 m wire, and the pistons' rₘₐₓ was 0.12 m. The speed of rotation ω was 3.14 radians/sec (30 rpm), and the vehicle 10 moved an average of 0.0032 m. Moreover, the movements of the masses 18 with respect to the rotation of the linear guides 14 were synchronized as discussed above. Remarkably, operation of the vehicle 10 produced a consistent deflection from its position 30 at rest of about 0.5°.

Since the equation to measure the force generated by the pendulum test is f=mg sin(θ), the force generated by the pendulum testing was f=32 kg*sin(0.5°)=0.279N. The mathematical formula described below predicted a force of 0.268N vs. 0.279N demonstrated by the pendulum testing. They differ by roughly 4%. This suggests that vehicle 10 is able to act as a reactionless drive—producing acceleration without reacting against any mass (whether it be ejected propellant, a ground surface, air, water, or other matter) outside the vehicle 10. Because many past touted reactionless drives have failed under testing, skepticism demanding further evidence is warranted.

To obtain an analytical assessment, Applicant tested the dynamic through an 10 ANSYS® Rigid Dynamics simulation of a 3D Solidworks model of the vehicle 10 structurally similar to the model shown in FIG. 1. (ANSYS is made by Ansys of Canonsburg, PA). The model comprised a 9-body 15.395 kg vehicle with 8 active bodies, including two pairs of 1.4838 kg, 310 mm×131 mm×24 mm piston guides rotating at a rate of 26 radians/second, and four pistons weighing just 0.1878 kg each. The vehicle chassis or frame 24 itself weighed 8.7084 kg. The 15 pistons were modeled as reciprocating in a sinusoidal pattern along a 240 mm travel length of the piston guides.

The simulation confirmed the existence of net acceleration in one direction. The ANSYS simulation computed the total distance traveled was 35.548 m over 6 seconds resulting in a net average acceleration of 1.975 m/s² and a resulting force of 30.4N. Obviously, this is short of what would be required to escape gravity. But in open space, a vehicle of this kind could potentially accelerate to 0.2 c in one year or less, enabling machine-based interstellar exploration in intragenerational timeframes. Scaled significantly way up to provide space for human habitation, the invention enables intragenerational interstellar exploration.

To further explore this behavior, a mathematical analysis of the behavior is presented below. First, the background for the analysis is presented. Then the mathematical treatment is presented.

Consider a model of the mechanical assembly shown in FIG. 1, except that only a single pair 15 of piston guides 14 is considered. As explained above, the assembly comprises a piston 18 that reciprocates along the length of a linear piston guide 14 while the piston guide 14 rotates.

As the piston 18 reciprocates (back and forth motion along the piston guide 14), it follows an orbital path 25 that is fully included within one hemisphere of the rotational sweep 27 of the piston guide 14. The piston 18 completes its orbital path 25 two times for every one full rotation of the piston guide 14. Assuming that the angular speeds of the piston guides 14 are kept constant, the pistons 18 reciprocate back and forth along their respective piston guides 14 in a smooth, sinusoidal pattern.

Each piston guide 14 comprises a guide chassis 11 (or in other embodiments, just a drive rod with a non-cylindrical cross-sectional profile that prevents rotation of the piston 18) that has a pivot point 34 at the center of a symmetric, uniformly constructed chassis 32. Because of this symmetrical construction, the center of mass of the piston guide 14 (not including the piston 18) on both sides of the pivot point 34 are equal.

Using a linear actuator 16 or other mechanism, the piston 18 is motivated along a linear path (linear from the perspective of the piston guide 14 and measured from the pivot point 34 of the piston guide 14 to the center of the piston 18) from rₘₐₓ to −rₘₐₓ with zero being the center point 34 of the piston guide 14 (see FIG. 2). The piston guide 14 is pivotally connected and bound to a vehicle chassis or frame 24. The controller 41 is programmed to operate the rotational actuators 12, which are rigidly mounted to the frame 24, in a non-steering mode that causes the piston guides 14 to rotate at a constant, steady speed ω relative to the vehicle chassis 24 (see FIG. 3). The controller 41 is also programmed to vary ω if desired, for example, starting, stopping, steering or for generating an impulse. In this treatment, ω is considered constant.

To set up the mathematical treatment, imagine the guide chassis 11's pivot point 34 being located at the origin of a CCS 30. As the guide chassis 32 rotates, it sweeps out a circle 27 that is also centered at the origin of the CCS 30. In this treatment, the piston orbit 25 is contained on the positive side of the x-axis, with the x-axis bisecting the piston orbit 25. The angle (θ) of the piston guide 14 relative to the CCS 30 is measured from the positive x-axis and increases from 0 to 2π radians (full 360° of rotation). Using the Polar Coordinate System (r,θ) overlaid on the Cartesian Coordinate System with both origins being in the same location, the distance of the piston 18 from the origin of the CCS 30 is defined by the equation:

rₚᵢₛₜₒₙ=rₘₐₓ cos(θ) (see FIG. 2). (3)
where rₚᵢₛₜₒₙ is a scalar value, rₘₐₓ is the absolute value of the maximum distance between the center of rotation (COR) of the piston guide 14 and the piston 18 itself, and θ is the angle of rotation of the piston guide 14 with respect to the X-axis.

The piston guide 14 rotates at co radians per second. The piston 18 is connected to the piston guide 14 with a varying distance from the piston guide 14's center of rotation (COR) based on equation (1&3). The piston 18 is motivated by a force sufficient to maintain a definite distance from the COR as the piston guide 14 rotates about the pivot point 34. The unit vector of the piston 18 is denoted by \vec{e}ᵣ in the radial direction and \vec{e}_{θ} in the transversal direction (see FIG. 10).

As set forth in eq. (1.11.9) of Fowles' & Cassiday's Analytical Mechanics, the acceleration of the piston can also be expressed in polar coordinates and the position, velocity, and acceleration of the piston's center are:

\vec{r}ₚᵢₛₜₒₙ₁=r\vec{e}ᵣ (4)

\vec{v}ₚᵢₛₜₒₙ₁=\dot{r}\vec{e}ᵣ+r\dot{θ}\vec{e}_{θ} (5)

\vec{a}ₚᵢₛₜₒₙ₁=(\ddot{r}−r\dot{θ}²)\vec{e}ᵣ+(r\ddot{θ}+2\dot{r}\dot{θ})\vec{e}_{θ} (6)
where rₘₐₓ is the absolute value of the maximum distance the center of rotation that the piston 18 can move within the piston guide 14 with the position function of piston 1 such that:

rₚᵢₛₜₒₙ₁=rₘₐₓ cos(ωt); where ωt=θ (7)

\dot{r}ₚᵢₛₜₒₙ₁=−rₘₐₓω sin(ωt) (8)

\ddot{r}ₚᵢₛₜₒₙ₁=−rₘₐₓω² cos(ωt) (9)

θ=ωt rad (10)

\dot{θ}=ω rad/sec (11)

\ddot{θ}=0 rad/sec² (12)

Knowing equation (6) results in (substitute equation (ωt) with θ);

\vec{a}ₚᵢₛₜₒₙ₁=[−rₘₐₓω² cos(θ)−rₘₐₓω² cos θ]\vec{e}ᵣ+[(rₘₐₓ cos(θ)*0)+(−2rₘₐₓω² sin(θ))]\vec{e}_{θ} (13)

Simplify;

\vec{a}ₚᵢₛₜₒₙ₁=[−2rₘₐₓω² cos(θ)]\vec{e}ᵣ−[2rₘₐₓω² sin(θ)]\vec{e}_{θ} (14)

Acceleration alone does not determine if an overall force can be achieved because it does not consider internal mass within the calculation. Case in point, when the system is at π/2 radians, the acceleration in the x direction is calculated to be −2*rₘₐₓω² and the piston at this point is exactly at the center of rotation (see FIG. 22 dashed circled area). Inertial mass when the piston is at the center of rotation is equal to zero because the radius is 0. FIG. 23 visually represent for magnitude and direction of force applied to the central chassis through the piston guides at the center of rotation. It is readily apparent that the magnitude of the mass is vital in determining the force acting upon the chassis. Therefore, to include magnitude of inertial mass in this treatment, Newton's second law of motion (F=ma) can be applied. Since the mass (m) is contained in a rotating system, we shall begin with the moment of inertia (I) calculation;

I=mr². Equation (15) results in; (15)

I=mₚᵢₛₜₒₙ(rₘₐₓ cos(θ))² (16)

The Polar acceleration function already expresses the constant rₘₐₓ in the calculation. Further, the magnitude of the mass is effectively expressed in the equation

mₚᵢₛₜₒₙ cos²(θ). (17)

Therefore;

I_{magnitude}=mₚᵢₛₜₒₙ cos²(θ) (18)

Results in; F=ma=I_{magnitude}a, and Multiplying equations (14) and (18) results in;

F=[mₚᵢₛₜₒₙ cos²(θ)(−2rₘₐₓω² cos(θ))]\vec{e}ᵣ−[(mₚᵢₛₜₒₙ cos²(θ))(2rₘₐₓω² sin(θ))]\vec{e}_{θ} (19)

Simplify;

F=[−2mₚᵢₛₜₒₙrₘₐₓω² cos³(θ)]\vec{e}ᵣ−[2mₚᵢₛₜₒₙrₘₐₓω² cos²(θ)sin(θ)]\vec{e}_{θ} (20)

The piston force equation (17.) will then be projected onto a Cartesian plane;

\vec{f}ₚᵢₛₜₒₙ₁=[(−2mₚᵢₛₜₒₙrₘₐₓω² cos³(θ)cos(θ))\hat{ι}+(−2mₚᵢₛₜₒₙrₘₐₓω² cos³(θ)sin(θ))Ĵ]\vec{e}ᵣ−[(−2mrₘₐₓω² cos²(θ)sin(θ)sin(θ))\hat{ι}+(−2mrₘₐₓω² cos²(θ)sin(θ)cos(θ))Ĵ]\vec{e}_{θ} (21)

Simplify;

\vec{f}ₚᵢₛₜₒₙ₁=[(−2mₚᵢₛₜₒₙrₘₐₓω² cos⁴(θ))\hat{ι}−(2mₚᵢₛₜₒₙrₘₐₓω² cos³(θ)sin(θ))Ĵ]\vec{e}ᵣ+[(2mₚᵢₛₜₒₙrₘₐₓω² cos²(θ)sin²(θ))\hat{ι}−(2mₚᵢₛₜₒₙrₘₐₓω² cos³(θ)sin(θ))Ĵ]\vec{e}_{θ} (22)

Integrate over 2π radians (full rotation—2 complete orbits of the piston);

∫₀^{2π}\vec{f}ₚᵢₛₜₒₙ₁=[(−2mₚᵢₛₜₒₙrₘₐₓω²∫₀^{2π} cos⁴(θ))\hat{ι}+(−2mₚᵢₛₜₒₙrₘₐₓω²∫₀^{2π}(cos³(θ)sin(θ)))Ĵ]\vec{e}ᵣ+[(2mₚᵢₛₜₒₙrₘₐₓω²∫₀^{2π} cos² θ sin² θ)\hat{ι}−(2mₚᵢₛₜₒₙrₘₐₓω²∫₀^{2π} cos³ θ sin θ)Ĵ]\vec{e}_{θ} (23)

Simplify;

$$\\ \begin{matrix}{\vec{f}}_{piston 1} = [ ( - {m}_{piston} {r}_{max} {ω}^{2} ( \frac{3 π}{2} ) ) \hat{ι} + ( 0 ) \hat{} ] {\vec{e}}_{r} + [ ( {m}_{piston} {r}_{max} {ω}^{2} ( \frac{π}{2} ) ) \hat{ι} - ( 0 ) \hat{} ] {\vec{e}}_{θ} & ( 24 )\end{matrix}$$

Simplify;

\vec{f}ₚᵢₛₜₒₙ₁=[(−mₚᵢₛₜₒₙrₘₐₓω²π)\hat{ι}]\vec{e}ᵣ (25)

Average directional force applied over integral is;

$$\\ \begin{matrix}{\vec{f}}_{piston 1} = \frac{1}{2 π} [ ( - {m}_{piston} {r}_{max} {ω}^{2} π ) \hat{ι} ] = [ ( - \frac{1}{2} {m}_{piston} {r}_{max} {ω}^{2} ) \hat{ι} ] & ( 26 )\end{matrix}$$

Let \vec{fₚᵢₛₜₒₙ₂(θₚ₂)} equal all the forces the system exerts on the piston 18 to compel the piston 18 to its proper location along its own orbital path 25 (see FIG. 1). The force exerted on the piston 18 is translated from the piston guide 14 to the piston 18. The resulting reactionary forces are transferred to the center of rotation (COR) and then to the chassis. Accordingly, for the second part of the treatment, the COR is the point at which the reactionary forces are calculated.

The Mesh Drive propulsion system utilizes pairs of counter rotating piston guides 14 and pistons 18. Accordingly, consider an additional piston guide and piston 18 counterrotating in the opposite direction and parallel to the initial piston guide discussed earlier. By including the second piston guide assembly which shall be counter rotating at the same rotational speed in the model (parallel to the initial piston guide assembly), torque due to the rotating system will be zero (canceled out). Since the piston guide will be assessed as if it were in the same Cartesian coordinate system as the first piston guide, the piston guide shall have the same initial setup in terms of θ and ω with the only difference being the direction of rotation from the initial position. In order to ensure consistency, the angle (θₚ₂) of the piston guide shall be calculated such that θₚ₂=2π−θ implying that θₚ₂=2π−ω. The distance of the piston from the COR can be determined by the function:

rₚ₂=rₘₐₓ cos(θₚ₂) (27)
where rₘₐₓ is the absolute value of the maximum distance the center of rotation that the piston 18 can move within the piston guide 14 with the position function of piston 1 such that:

\vec{r}ₚᵢₛₜₒₙ₂=rₚ₂\vec{e}ᵣ (28)

\vec{v}ₚᵢₛₜₒₙ₂=\dot{r}ₚ₂\vec{e}ᵣ+rₚ₂\dot{θ}ₚ₂\vec{e}_{θ} (29)

\vec{a}ₚᵢₛₜₒₙ₂=(\ddot{r}ₚ₂−rₚ₂\dot{θ}²ₚ₂)\vec{e}ᵣ+(rₚ₂\ddot{θ}ₚ₂+2\dot{r}ₚ₂\dot{θ}ₚ₂)\vec{e}_{θ} (30)

rₚᵢₛₜₒₙ₂=rₘₐₓ cos(2π−ωt); where 2π−ωt=θₚ₂; (31)

\dot{r}ₚᵢₛₜₒₙ₂=−rₘₐₓω sin(ωt) (32)

\ddot{r}ₚᵢₛₜₒₙ₂=−rₘₐₓω² cos(ωt) (33)

θₚ₂=(2π−ωt)rad (34)

\dot{θ}ₚ₂=−ω rad/sec (35)

\ddot{θ}ₚ₂=0 rad/sec² (36)

rₚᵢₛₜₒₙ₂=rₘₐₓ cos(θₚ₂); where (2π−θ)=θₚ₂; and (ωt)=θ (37)

Knowing equation (30) results in (substitute equation (2π−ωt) with θₚ₂);

\vec{a}ₚᵢₛₜₒₙ₂=[−rₘₐₓω² cos(θ)−rₘₐₓω² cos(θₚ₂)]\vec{e}ᵣ+[(rₘₐₓ cos(θₚ₂)*0)+(−2rₘₐₓω² sin(θ))]\vec{e}_{θ} (38)

Simplify;

\vec{a}ₚᵢₛₜₒₙ₂=[−rₘₐₓω²(cos(θ)+cos(θₚ₂))]\vec{e}ᵣ−[2rₘₐₓω² sin(θ)]\vec{e}_{θ} (39)

I=m(rₘₐₓ cos(θₚ₂))² remove the constant already included in the Polar acceleration equation (rₘₐₓ) therefore, (40)

I_{magnitude}=mₚᵢₛₜₒₙ cos²(θₚ₂) (41)

Therefore, you have F=ma=I_{magnitude}a, and Multiplying equations (39) and (41) results in;

F=[mₚᵢₛₜₒₙrₘₐₓ cos²(θₚ₂)(−rₘₐₓω²(cos(θ)+cos(θₚ₂)))]\vec{e}ᵣ−[(mₚᵢₛₜₒₙrₘₐₓ cos²(θₚ₂))(2rₘₐₓω² sin(θ))]\vec{e}_{θ} (42)

Simplify;

F=[−mₚᵢₛₜₒₙrₘₐₓω² cos²(θₚ₂)(cos(θ)+cos(θₚ₂))]\vec{e}ᵣ−[2mₚᵢₛₜₒₙrₘₐₓω² cos²(θₚ₂)sin(θ)]\vec{e}_{θ} (43)

The piston position equation (43) will then be projected onto a Cartesian plane;

\vec{f}ₚᵢₛₜₒₙ₂=[(−mₚᵢₛₜₒₙrₘₐₓω² cos²(θₚ₂)cos(θ)(cos(θ)+cos(θₚ₂)))\hat{ι}+(−mₚᵢₛₜₒₙrₘₐₓω² cos²(θₚ₂)sin(θ)(cos(θ)+cos(θₚ₂)))Ĵ]\vec{e}ᵣ−[(−2mₚᵢₛₜₒₙrₘₐₓω² cos²(θₚ₂)sin(θ)sin(θ))\hat{ι}+(2mₚᵢₛₜₒₙrₘₐₓω² cos²(θₚ₂)sin(θ)cos(θ))Ĵ]\vec{e}_{θ} (44)

Simplify;

\vec{f}ₚᵢₛₜₒₙ₂=[(−mₚᵢₛₜₒₙrₘₐₓω² cos²(θₚ₂)cos(θ)(cos(θ)+cos(θₚ₂)))\hat{ι}+(−mₚᵢₛₜₒₙrₘₐₓω² cos²(θₚ₂)sin(θ)(cos(θ)+cos(θₚ₂)))Ĵ]\vec{e}ᵣ−[(−2mₚᵢₛₜₒₙrₘₐₓω² cos²(θₚ₂)sin²(θ))\hat{ι}+(2mₚᵢₛₜₒₙrₘₐₓω² cos²(θₚ₂)sin(θ)cos(θ))Ĵ]\vec{e}_{θ} (45)

Integrate over 2π radians (full rotation—2 complete orbits of the piston);

∫₀^{2π}\vec{f}ₚᵢₛₜₒₙ₂=[(−mₚᵢₛₜₒₙrₘₐₓω²∫₀^{2π} cos²(θₚ₂)cos(θ)(cos(θ)+cos(θₚ₂)))\hat{ι}+(−mₚᵢₛₜₒₙrₘₐₓω²∫₀^{2π} cos²(θₚ₂)sin(θ)(cos(θ)+cos(θₚ₂)))Ĵ]\vec{e}ᵣ+[(2mₚᵢₛₜₒₙrₘₐₓω²∫₀^{2π} cos²(θₚ₂)sin²(θ))\hat{ι}−(2mₚᵢₛₜₒₙrₘₐₓω²∫₀^{2π} cos³(θ)sin(θ))Ĵ]\vec{e}_{θ} (46)

Simplify;

$${\vec{f}}_{pis ton 2} = [ ( - {m}_{p i s t o n} {r}_{max} {ω}^{2} ( \frac{3 π}{2} ) ) \hat{i} + ( 0 ) \hat{j} ] {\vec{e}}_{r} + [ ( {m}_{p i s t o n} {r}_{max} {ω}^{2} ( \frac{π}{2} ) ) \hat{i} - ( 0 ) \hat{j} ] {\vec{e}}_{θ} \qquad ( 47 )$$

Simplify;

\vec{f}ₚᵢₛₜₒₙ₂=[(−mₚᵢₛₜₒₙrₘₐₓω²π)\hat{ι}]\vec{e}ᵣ (48)

Average directional force applied over integral is;

$$\\ \begin{matrix}{\vec{f}}_{piston 2} = \frac{1}{2 π} [ ( - {m}_{piston} {r}_{max} {ω}^{2} π ) \hat{ι} ] = [ ( - \frac{1}{2} {m}_{piston} {r}_{max} {ω}^{2} ) \hat{ι} ] & ( 49 )\end{matrix}$$

This equation establishes the relationship between the angular velocity of the piston guide 14, the distance the piston travels from the COR, and the acceleration of the vehicle 10. The controller 41 can control the speed of the vehicle 10 by simply changing the angular speeds of the piston guides 14. In addition, the speed of the vehicle can also be controlled by controller 16 which determines the distance the piston travels from the COR. Notably, the net force acting on the first piston is equal to the net force acting on the second piston assuming a symmetrical orbit is desired. The vehicle can be maneuvered in 3 dimensional space by using asymmetrical orbits which will motivate the vehicle in virtually direction.

The formulas in equations (48) and (49) can be generalized. In the absence of operation of any linear guides besides the first and second linear guides, a magnitude of the forward acceleration of the vehicle is characterizable by the formula:

$$\\ \begin{matrix}{a}_{vehivle} = \frac{{m}_{pistons}}{{m}_{vehicle}} * ( {r}_{max} {ω}^{2} ) & ( 50 )\end{matrix}$$

where mₚᵢₛₜₒₙₛ is a sum of the masses of all pistons within the system, m_{vehicle} is the mass of the vehicle, rₘₐₓ is a maximum diameter of the concentric orbits of the first and second masses, and ω is the angular speed, in radians, of each of the first and second masses.

This embodiment includes, but is not limited to a second pair of piston guides ½π out of phase and rotating about the xz Cartesian plane with an associated polar coordinate system set up in the same way as with the first piston guide pair. The result of meshing two piston guide pairs via a chassis is the following generalized equation:

$$\\ \begin{matrix}{a}_{vehivle} = 2 \frac{{m}_{pistons}}{{m}_{vehicle}} * ( {r}_{max} {ω}^{2} ) & ( 51 )\end{matrix}$$

This embodiment includes any number of piston guide pairs in meshed or unmeshed configurations that produce an internally derived overall net force.

This embodiment includes a limitless number of orbit functions whereby the orbit function determines the location of the piston within a piston guide whereby the timing of the location of the piston within the sweep of the piston guide creates an orbit about the center of rotation that generates an internally derived directional force.

There are many alterations to the embodiments discussed above that fit within the scope of the invention. For example, the embodiments above describe vehicles 10 that utilize both rotational and linear actuators 12 and 16. In the embodiments of FIGS. 18-20, the pistons 18 are coupled not only to the rotational guides 12 but also to circular tracks 75 that are coincident with the piston orbits 25. The addition of the circular track 75 gives rise to several new embodiments. In FIGS. 18-20, the linear actuator 16 is removed because the piston 18 is constrained by track 75 to move along its circular orbit 25 as the piston guide 14 rotates.

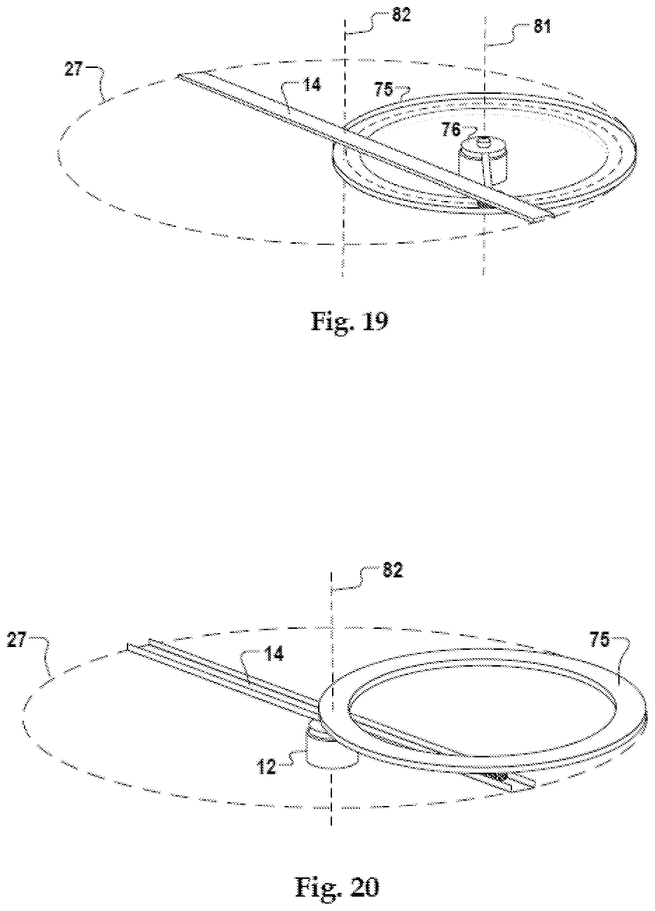

In FIGS. 18 and 19, a single orbit actuator 76—for example, one centered along the axis 81 of the piston orbit 25—for each piston 18 causes it to move around the circular track 75, which in turn causes its linear guide 14 to rotate. The orbit actuator 76, in combination with a second orbit actuator (not shown) for the counter-rotating piston 18, guide the pistons 18 about their coaxial orbit functions 25 without assistance from linear actuators 16 to reciprocate the pistons 18 about their linear guides 14 and without assistance from rotational actuators 12 that directly rotate the linear guides 14. Magnets may be employed to prevent the piston 18 from starting or stopping at a position in which the force imparted by the orbit actuator arm 77 are perpendicular to the piston track 14. While FIGS. 18 and 19 illustrate a physical track 75, it will be understood, of course, that the circular track 75 could be eliminated from FIGS. 18 and 19 and the piston 18 would still follow a virtual track 79 (shown in dashed lines).

In one modification of FIGS. 18 and 19, the orbit actuator 76 itself is mounted on a linear track projecting radially from axis 82 that enables its distance from the COR 34 to be adjusted in order to effect steering movements. In this embodiment, the arm 77 is telescoping, enabling the vehicle 10 to contract the radius of the piston orbit 25 as well.

The embodiment of FIG. 20 includes a single rotational actuator 12 that directly rotates the piston guide 12 along its axis 82 of rotation. Because the piston 18 is constrained to move along a circular track 75, the piston 18 is forced to reciprocate along the length of the piston guide 14.

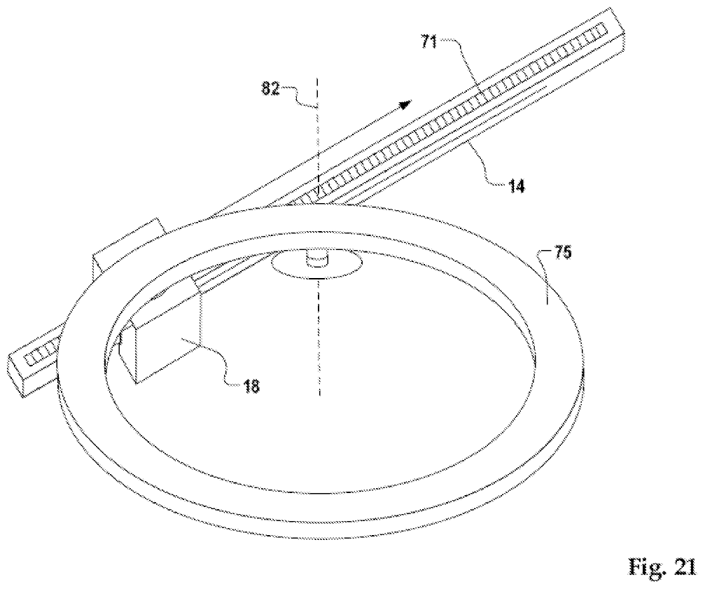

In FIG. 21, the rotational actuator 16 is removed and the piston 18 is driven solely by a linear actuator 16. This works because the piston 18 is constrained by the track 75 to move along its orbit 25, and as it moves along the track 75, the piston guide 18 itself is forced to rotate. In a modification of FIG. 21, two actuators—one for moving the piston 18 along its linear guide 14 and the other for moving the piston 18 along its circular track 75—are built into the piston 18.

Also, it will be noted that because the pistons 18 are eccentric with respect to the linear guides 14 (except for a single point along their orbits), the linear guides 14 are imbalanced. This has the potential to increase wear on the pivots 34, and in moderate-to high gravity situations, to torques on the pivots 34. Embodiments that incorporate a circular track may be advantageous in reducing such torques and wear.

The vehicles 10 of the various embodiments discussed above can be characterized in many different ways. According to one characterization that dwells on the unique relationship between the piston orbit 25 and the linear guide 14's circular sweep 27, the vehicle 10 comprises two counter-revolving masses 18 driven by actuators 12 and/or 16 to both rotate and to reciprocate along the length of two linear guides 14. The masses 18 revolve about coaxial circular orbital paths 25 centered around a first, common axis 81 that is perpendicular to the planes of the orbits 25 (see FIG. 19). The linear guides 14 counter-rotate about a second axis 82 that is perpendicular 24 to the circular sweeps 27 of the linear guides 14. The second axis is parallel to and displaced an amount equal to the radius of the orbital paths 25 from the first axis.

Moreover, in one embodiment, the counter-revolving masses 18 intersect the second axis along their respective orbits 25. Also, when the counter-revolving masses 18 move along their respective orbital paths 25 at constant opposite angular velocities, each counter revolving mass 18 moves at a sinusoidal speed, with respect to the linear guide 14, from a first end of the linear guide 14 carrying it to the opposite end of the linear guide and back again.

Furthermore, the linear speed of each counter-revolving mass 18, with respect to its linear guide 14, reaches a minimum at the first and opposite ends of the linear guide 18. This occurs when the linear guide 14 is oriented along a first line intersecting two points along the masses' orbital paths 25 where the masses 18 overlap. By contrast, the speed of each counter-revolving mass 18 reaches a maximum when the counter-revolving masses 18 intersect the first axis, which occurs when the linear guide 14 is oriented along a second line that runs through the first axis perpendicular to the first line. Also, each time the counter-revolving masses 18 intersect the first axis along their orbits, a directional component of their velocities changes from one direction to the opposite direction along the first line. Consequently, regardless of the angular orientation or position of the counter-revolving masses with respect to the linear guides, each of the counter-revolving masses is always positioned at or on one side of the first axis.

Earlier in this specification, many methods of steering are discussed. There are further ways that the vehicle 10 can steer. In one embodiment, the controller 41 steers the vehicle 10 by changing a phase between the rotational orbits 25 of the first and second pistons 18. Changing the phase between the angular velocities rotationally shifts the positions of two opposite points along the concentric circular paths at which the pistons 18 overlap. Because the vehicle 10 is impelled in a direction that lies on a line intersecting the two overlap points, shifting the phase of these two points effectively steers the vehicle 10. In another embodiment, the vehicle 10 is equipped, via another linear actuator, to spread the linear guides 14 of a pair 15 of linear guides 14 apart. The controller 41 steers the vehicle 10 by altering a distance between the linear guides 14.

It will be appreciated that the embodiments disclosed herein have many different and independent forms of utility, from production of a reactionless or inertial drive to incorporation of steering mechanisms to educational apparatuses that challenge students in physics to model 25 sized novelty items that can be displayed on a shelf, dresser, or desk. All of these are considered to be within the scope and intent of the present invention.

It will be understood that many other modifications could be made to the embodiments disclosed herein without departing from the spirit of the invention. Having thus described exemplary embodiments of the present invention, it should be noted that the disclosures contained in the drawings are exemplary only, and that various other alternatives, adaptations, and modifications may be made within the scope of the present invention. Accordingly, the present invention is not limited to the specific embodiments illustrated herein, but is limited only by the claims of this patent.

1. A vehicle comprising:
a frame;
a pair of first and second linear guides coupled to the frame for counter-revolving movement about a common axis of rotation;
first and second counter-revolving masses mounted to the linear guides that are guided and configured to reciprocate along travel lengths of the linear guides as they rotate;
one or more actuators coupled to the first and second linear guides to counter-rotate the first and second linear guides and reciprocate the first and second counter-revolving masses along the travel lengths of the linear guides as they rotate; and
a first mode of operation in which the first and second masses each travel in opposite rotational directions about congruent coaxial orbit functions, wherein the congruent coaxial orbit functions are centered about an orbital axis that is displaced from the common axis of rotation.

2. The vehicle of claim 1, further comprising first and second linear actuators mounted on the first and second linear guides, respectively, wherein the first and second linear actuators propel the first and second counter-revolving masses to reciprocate along the respective travel lengths of their respective linear guides.

3. The vehicle of claim 2, wherein at least a portion of the first and second linear actuators are contained within the first and second counter-revolving masses, respectively.

4. The vehicle of any one of claims 1-3, further comprising one or more rotational actuators that counter-rotate the linear guides.

5. The vehicle of any one of claims 1-3, wherein:
each counter-revolving mass intersects the common axis of rotation of the linear guides at one point along the mass's orbit; the first mode is characterized by the counter-revolving masses orbiting their respective orbital paths at constant angular speeds, resulting in each counter-revolving mass moving at a sinusoidal speed, with respect to the linear guide, between a first end and an opposite end of the travel length of the respective linear guide; the sinusoidal speed of each counter-revolving mass reaches a minimum at opposite ends of the travel length of its linear guide, which occurs when the linear guide is oriented along a first line intersecting two points along the masses' orbital paths where the masses overlap; the sinusoidal speed of each counter-revolving mass reaches a maximum when the counter-revolving mas intersects the common axis of rotation, which occurs when the linear guide is oriented along a second line that intersects the common axis of rotation at a perpendicular to the first line.

6. The vehicle of any one of claims 1-3, wherein each counter-revolving mass is arranged to reciprocate along the travel length of its corresponding linear guide and back again in a first period of time that is equal to a second period of time required for the corresponding linear guide to complete a full rotation.

7. The vehicle of any one of claims 1-3, wherein each of the first and second counter-revolving masses complete two revolutions about its respective orbital axis for every single orbit of the first and second linear guides in the first mode of operation.

8. The vehicle of any one of claims 1-3, further comprising a second mode of operation in which the first and second masses each travel in opposite rotational directions at equal and opposite speeds about noncongruent and non-coaxial orbit functions.

9. The vehicle of any one of claims 1-3, further comprising a controller that receives remote commands and responsively controls the angular speeds of the linear guides.

10. The vehicle of claim 9, wherein the controller controls a length of reciprocation of the first and second masses.

11. The vehicle of claim 10, wherein the controller drives the first and second counter-revolving masses at opposite and equivalent speeds, and wherein the first mass's orbit has a mean eccentricity from the common axis of rotation that is greater than or less than a mean eccentricity of the second mass's orbit.

12. The vehicle of any one of claims 1-3, further comprising a controller operable to control a forward acceleration of the vehicle by changing the angular speeds of the first and second linear guides.

13. The vehicle of any one of claims 1-3, wherein: responsive to rotating the first and second masses, at equal and opposite angular velocities, resulting in the masses overlapping each other at two opposite points along their orbital paths, produces a thrust along a vector that intersects said two opposite points.

14. The vehicle of claim 13, further comprising a controller operable to steer the vehicle by changing a phase between the rotational orbits of the first and second counter-revolving masses; wherein changing the phase between the angular velocities rotationally shifts positions of the two opposite points along the circular orbital paths at which the masses overlap.

15. (canceled)

16. (canceled)
